(19) United States
(12) Patent Application Publication
(10) Pub. No.: US 2005/0236014 A1
(43) Pub. Date: Oct. 27, 2005

(54) System and method for a sonde sensor cleaning system

(75) Inventors: Elijah L. Scott, Loveland, CO (US); Thomas O. Mitchell, Fort Collins, CO (US)

Correspondence Address: SETTER OLLILA, LLC, 2060 BROADWAY, SUITE 300, BOULDER, CO, 80302, US

(73) Assignee: HACH COMPANY

(21) Appl. No.: 11/003,891

(22) Filed: Dec. 3, 2004

Related U.S. Application Data
(60) Provisional application No. 60/564,456, filed on Apr. 22, 2004.

(51) Int. Cl. B08B 7/00

(52) U.S. Cl. 134/6

(57) ABSTRACT

A sonde cleaning brush is disclosed that has a plurality of bristles extending from the brush surface. The bristles have a stiffener attached to the bristles causing the stiffness of the bristles to increase along the length of the brush while preserving the flexibility of the bristles perpendicular to the brush length. There may be one or more stiffeners attached to the brush bristles.

### RELATED APPLICATIONS

This application claims the benefit of U.S. provisional application No. 60/564,456 filed on Apr. 22, 2004 entitled “A System and Method for A Sonde Sensor Cleaning System,” which hereby is incorporated by reference into this application.

### BACKGROUND OF THE INVENTION

1. Field of the Invention

The invention is related to multi-parameter sondes, and in particular, to a cleaning system and method for multi-parameter sonde sensors.

2. Statement of the Problem

Multi-parameter sondes are typically deployed in surface waters (rivers, lakes, estuaries, etc.) to take measurements for a plurality of parameters. Examples of some of the types of measurements taken are: pH, dissolved oxygen, turbidity, temperature, conductivity, etc. Some sonde are deployed for extended periods of time, for example up to 7 months. Some of the measurements require shining light into the water and measuring the amount of light reflected or scattered back into the sensor. These sensors typically have a window through which the light passes. During extended deployment, the windows may become fouled by sediment or biological growth. Some sensors have wipers that are meant to clean the surface of the window. However the wipers typically are only for one sensor, do not work well and are hard to replace. Other sensor types may not use light to take the measurement, but may still need the active area of the sensor cleaned. For example, a dissolved oxygen measurement may use membrane-covered polarographic detector to take the measurement. The membrane may need to be cleaned during deployment. Without cleaning the membrane will need to be replaced often at considerable time and expense.

Therefore there is a need for a system and method for cleaning sensors in a sonde.

### SUMMARY OF THE SOLUTION

A system and method for cleaning sensors is disclosed.

### BRIEF DESCRIPTION OF THE DRAWINGS

FIG. 1 is a top view of a multi-parameter sonde in an example of the invention.

FIG. 2 is a front view of a cleaning arm assembly in an example embodiment of the invention.

FIG. 3 is a side view of a cleaning arm assembly in an example embodiment of the invention.

FIG. 4 is a drawing of a brush in an example embodiment of the invention.

FIG. 5 is a sketch of a prior art brush with splayed bristles.

FIG. 6a-d are front views of brushes with multiple stiffeners in example embodiments of the invention.

FIG. 7 is a front view of a brush with a stiffener with a variable height in an example embodiment of the invention.

FIG. 8 is an assembly drawing of a cleaning arm assembly in an example embodiment of the invention.

FIG. 9 is a drawing of a cleaning arm in an example embodiment of the invention.

### DETAILED DESCRIPTION OF THE PREFERRED EMBODIMENT

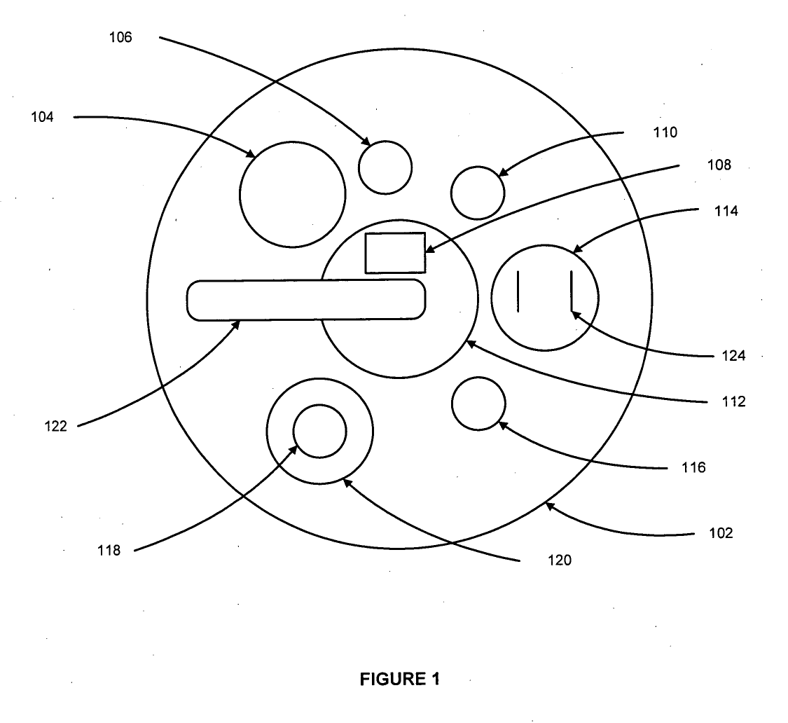

FIGS. 1-9 and the following description depict specific examples to teach those skilled in the art how to make and use the best mode of the invention. For the purpose of teaching inventive principles, some conventional aspects have been simplified or omitted. Those skilled in the art will appreciate variations from these examples that fall within the scope of the invention. Those skilled in the art will appreciate that the features described below can be combined in various ways to form multiple variations of the invention. As a result, the invention is not limited to the specific examples described below, but only by the claims and their equivalents.

FIG. 1 is a top view of a sonde 102 in an example embodiment of the current invention. Sonde 102 has sensor probes 104, 106, 110, 112, 114, 116, and 120 installed. Sensor probes 112 and 120 have windows 108 and 118 respectively, necessary for taking the measurements by the sensor probe. Sensor probe 114 has electrodes 124 necessary for taking measurements for the probe. Sensor probe 112 has cleaning arm assembly 122 configured to clean a number of the sensor probes. Sensor probe 112 is configured to be place in the center probe position of sonde 102 such that cleaning arm assembly 122 can reach all other sensor probe positions with a 360 degree rotation. Cleaning arm assembly 122 is configured to clean window 108 in probe 112, as well as the other sensor probes placed around sensor probe 112.

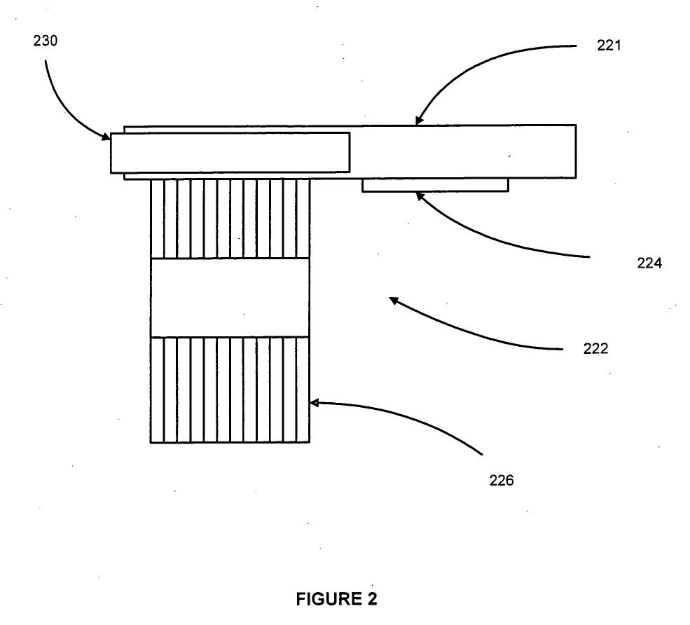

FIG. 2 is a front view of a cleaning arm assembly 222 in an example embodiment of the invention. Cleaning arm assembly comprises arm 221, wiper 224, brush 226, and retaining clip 230. In operation cleaning arm assembly is attached to driver in probe 112 (not shown). Wiper 224 is configured to clean window 108 in probe 112. Brush 226 is configured to clean the windows or active sensor elements of the probes installed in the probe ports located around probe 112, for example probes 114, 120 and the like.

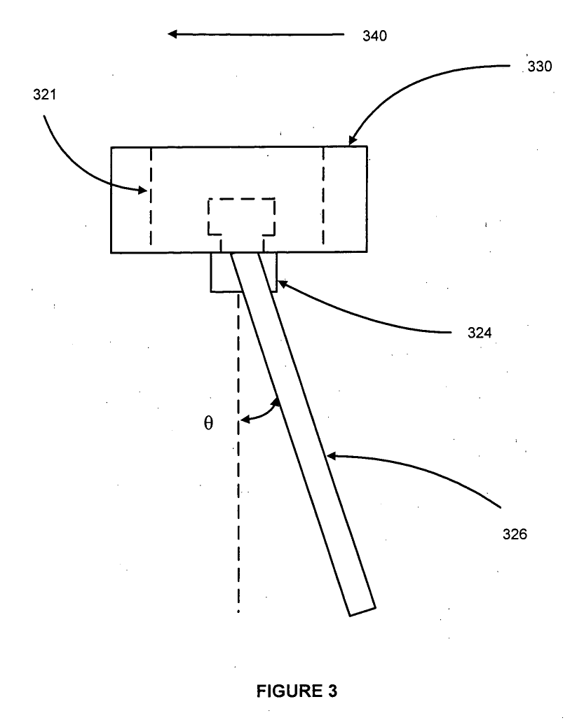

FIG. 3 is a side view of a cleaning arm assembly in an example embodiment of the invention. Brush 326 makes an angle θ with respect to a plane perpendicular to the surface of arm 321. Brush angle θ allows the brush bristles to be longer for the same probe sensor height. Longer bristles give more flexibility to the bristles. Brush angle θ is configured to allow brush 326 to be dragged across an active sensor area in the cleaning direction shown by arrow 340. By dragging the tilted bristles across the sensor area to be cleaned, the surface area of the bristles contacting the sensor area is increased. In one example embodiment of the invention, the brush angle is 20 degrees.

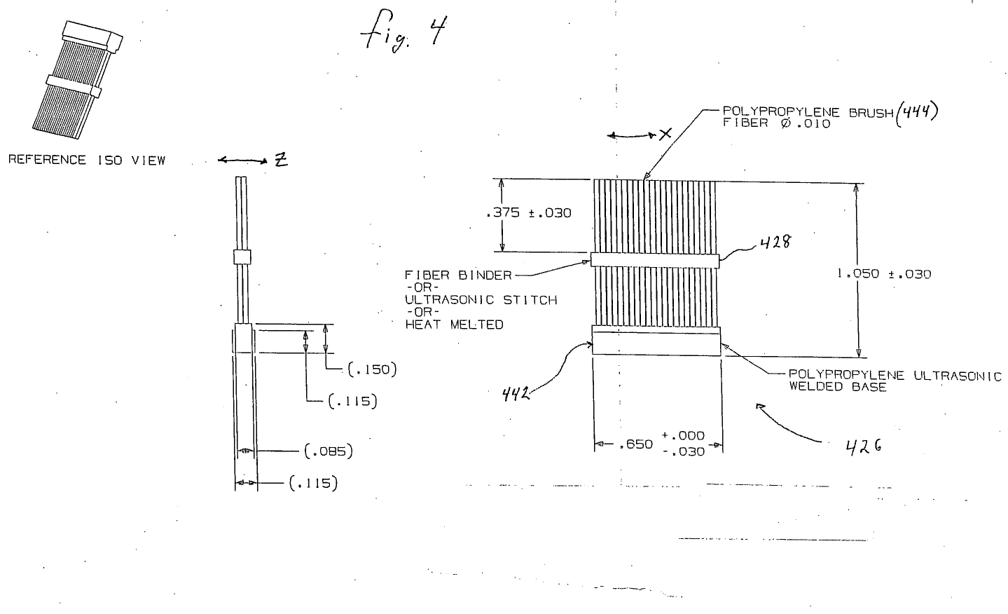

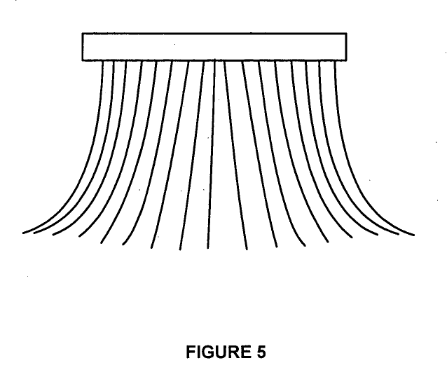

FIG. 4 is a drawing of a brush in an example embodiment of the invention. Brush 426 is comprised of individual bristles 444 extending from brush base 442. Brush 426 has a stiffener 428 constraining bristles 444 in the middle section of the bristles. Stiffener captures the individual bristles and binds the individual bristles together in the middle section of the brush. Stiffener constrains movement of the bristles along the long axis of the brush (the x-axis) while preserving the motion of the bristles perpendicular to the long axis of the brush (the z-axis). By constraining the bristle movement along the x-axis, the tendency of the bristles to splay has been reduced. FIG. 5 shows a sketch of a brush with splayed bristles. The stiffener may be created by using a number of techniques. The bristles may be melted together, they may be bonded together using an adhesive, they may be sewn together, they may be welded together, they may be clamped together or the like. In one example embodiment of the invention, a bag sealer is used to join the bristles together.

The height and placement of stiffener 428 can be varied to adjust the amount of force the bristles apply to the active sensor areas. For example, moving the stiffener closer to the ends of the bristles, causes a higher stiffness of the brush in the anti-splay direction. The stiffness of the individual bristles can also be varied by changing the diameter of the bristles, changing the number of bristles per inch, or changing the material of the bristles. For example, metal bristles are typically stiffer than plastic bristles. The angle the brush makes with respect to the cleaning direction may also be varied along with the stiffness of the brush to adjust the amount of force the bristles apply to the sensor area to be cleaned.

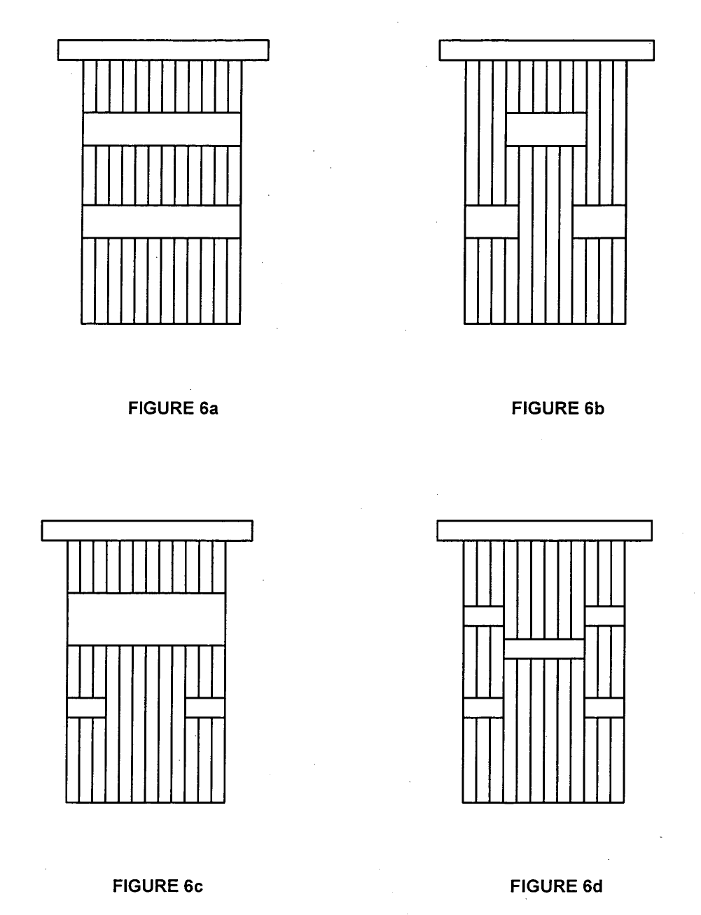

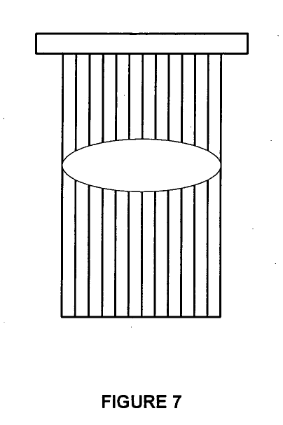

In another example embodiment of the invention, there may be multiple stiffeners attached to the bristles. FIG. 6a, 6b, 6c and 6d show a few examples of a brush with multiple stiffeners. The placement of the stiffeners may increase the stiffness of the brush on the ends of the brush more than in the middle of the brush (see FIG. 6c). In another example embodiment of the invention, the height of the stiffener may vary across the width of the brush. FIG. 7 is a drawing of an example embodiment where the stiffener thickness changes across the width of the brush.

Controlling the stiffness of the brush allows brushes to be created for different conditions. For example, a stiffer brush may be used in the summer when there is higher biological growth and a softer brush may be used in the winter when the brush is primarily cleaning sediment.

In one example embodiment of the invention, the bristle in the bush may be treated with an anti-fouling compound. One example of an anti-fouling agent is material 4,5-Dichloro-2-n-octyl-4-isothiazolin-3-one (CAS registry number: 64359-81-5) used by Kuraray Co., Ltd. Of 12-39, 1-chrome, Umeda, Kita-Ku. Osaka, Japan. Other parts of the cleaning arm assembly may also be treated with an anti-fouling agent. In another example embodiment of the current invention, the brush bristles would be hollow and the hollow spaces in the bristles would be filled with an anti-fouling agent. The anti-fouling agent may be a time release anti-fouling compound.

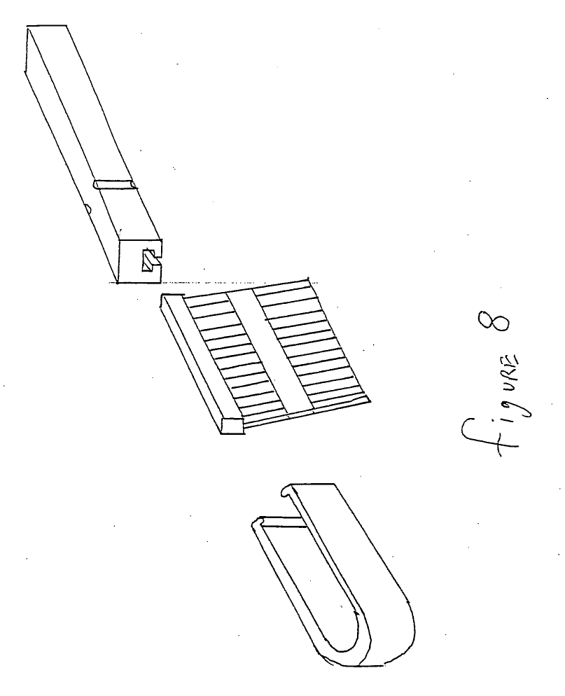

In one example embodiment of the invention, the brush in the cleaning arm assembly would be configured to be field replaceable. FIG. 8 shows an isometric view of an assembly drawing for the cleaning arm assembly. Brush slides into a slot in the cleaning arm and the clip snaps onto the cleaning arm, locking the brush in place. Because the brush is held in place with the clip, the brush can be replaced by removing the clip. Clip is configured to be removed by hand without using any tools. This simplifies the field replacement of the brush. The wiper may also be attached to the brush (not shown) such that when the brush is replaced the wiper is also replaced. In another example embodiment of the invention, the brush would be an integral part of the cleaning arm.

Because the brush is easily field replicable, the sonde may track when the brush needs to be replaced. When the brush needs replacement the sonde may set an alarm or warning so that the user will be notified. There are a number of ways to determine when the brush may need to be replaced. For example, the brush may need replacement after a set number of cleaning cycles or after a time period has expired. In another example embodiment of the invention, the sonde would contain two sensors for the same parameter, for example 2 dissolved oxygen sensors. The sonde would be configured to clean one sensor and to leave the second sensor uncleaned. As the uncleaned sensor accumulated sediment and biological growth, the response time between the two sensors to a change in the measured parameter would diverge. When the response time of the cleaned sensor began to shift to match the response time of the second uncleaned sensor, the brush would need to be replaced.

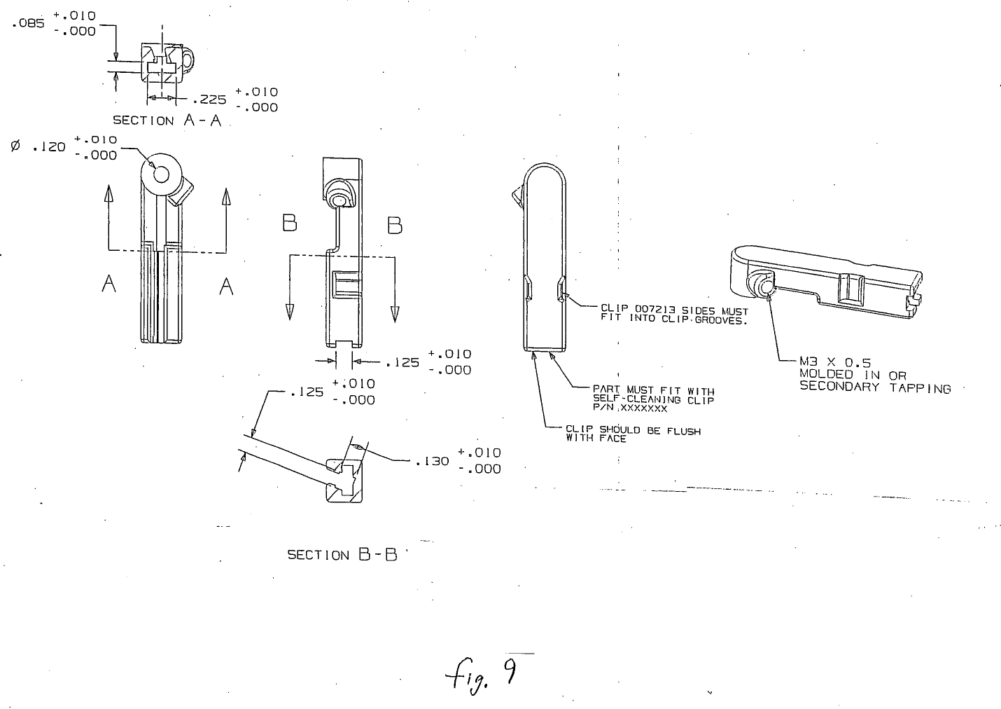

FIG. 9 is a drawing of the cleaning arm in an example embodiment of the invention. Section AA shows a view of the opening in the cleaning arm where the wiper is inserted. View BB is a sectional view showing the slot where the brush is inserted.

1-12. (canceled)

13. A method, comprising:
brushing an active sensor element of a sensor installed in a sonde with a cleaning brush in a cleaning direction, where the cleaning brush has a plurality of bristles having a first end attached to a brush base and a second end opposite the first end and where a stiffener is attached between the first end and the second end of the bristles.

14. The method of claim 13 where the bristles are tilted at an angle with respect to a plane is perpendicular to the cleaning direction.

15. The method of claim 14 where the angle is equal to approximately 20 degrees.

16. The method of claim 13 where the active sensor element is a window.

17-20. (canceled)
